(19) United States
(12) Patent Application Publication
(10) Pub. No.: US 2010/0332555 A1
(43) Pub. Date: Dec. 30, 2010

(54) CONTENT PLAYBACK DEVICE AND PROGRAM

(76) Inventor: Tatsuya Mitsugi, Tokyo (JP)

Correspondence Address: BIRCH STEWART KOLASCH & BIRCH, PO BOX 747, FALLS CHURCH, VA, 22040-0747, US

(21) Appl. No.: 12/865,080

(22) PCT Filed: Feb. 20, 2009
(86) PCT No.: PCT/JP2009/000730

§ 371 Date: Jul. 28, 2010

(30) Foreign Application Priority Data
Apr. 23, 2008 (JP) 2008-112769

(51) Int. Cl. G06F 17/30

(52) U.S. Cl. 707/803; 707/E17.005; 707/E17.044

(57) ABSTRACT

A content playback device extracts pieces of additional information from a musical piece database 2 to create an order list 3 in which the pieces of additional information are listed in a playback order of tracks, selects and extracts pieces of additional information to be listed in the order list 3 from identical content data recorded into a plurality of types of recording media 5 according to priority levels based on the access times required to access the recording media 5 respectively, and plays back musical piece data recorded in the recording media 5 in the playback order of the order list 3 on the basis of track paths acquired from the musical piece database 2.

### FIELD OF THE INVENTION

The present invention relates to a content playback device that reads content data, such as data about a musical piece, from a recording medium to play back the content data, and a program that causes a computer to operate as this content playback device.

### BACKGROUND OF THE INVENTION

As a related art content playback device, there is an automatic playing device disclosed by, for example, patent reference 1. In this device, a directory structure is formed as the data holding structure of a storage means, a plurality of music data each showing a musical piece, and playback order data showing the order of playback of a plurality of music data are stored in one directory, and the plurality of music data are played back in the order specified by the playback order data.

Furthermore, a music playback device having a facilitated registration process of registering playback order data is disclosed by patent reference 2. Playlist data defining the playback order of music data handled by this music playback device are comprised of item data each corresponding to music data, and the item data are comprised of number data, check mark data, etc. The music data are played back in the playback order defined by the number data of the item data, and the user is enabled to register whether or not each music data can be played back by simply specifying corresponding check mark data presented for the user via a display.
[Patent reference 1] JP 2001-109470A
[Patent reference 2] JP 2006-196058A

A problem with related art devices is that in the case of handling content data recorded into different types of recording media, such as a CD (Compact Disc), a USB (Universal Serial Bus), and a hard disk drive, they cannot search for and extract musical piece data which are objects to be played back to set a playback order arbitrarily without being aware of the types of recording media.

For example, the content playback device disclosed by patent reference 1 plays back music data stored in one directory in the order defined by the playback order data, but does not take into consideration music data recorded into different types of recording media. Furthermore, the content playback device disclosed by patent reference 2 cannot systematically carry out control of the playback order of music data recorded into different types of recording media.

The present invention is made in order to solve the above-mentioned problems, and it is therefore an object of the present invention to provide a content playback device that can search for and extract content data, such as musical pieces which are objects to be played back, without being aware of a plurality of types of recording media by handling the plurality of types of recording media systematically, and a program that causes a computer to operate as this content playback device.

### DESCRIPTION OF THE INVENTION

In accordance with the present invention, there is provided a content playback device including: a database creating means for extracting pieces of additional information each for specifying a content from a plurality of types of recording media into which content data and the above-mentioned pieces of additional information are recorded to create a content database into which path information showing a recording place of the above-mentioned additional information and the above-mentioned content data are registered for each content; an access time detecting means for detecting an access time required to access content data recorded into each of the above-mentioned recording media; a priority level setting means for, in a case in which identical content data is recorded into each of the above-mentioned plurality of types of recording media, assigning priority levels to pieces of additional information of the contents respectively according to the access time required to access content data recorded into each of the recording media which is detected by the above-mentioned access time detecting means; an order list extracting means for extracting pieces of additional information from the above-mentioned content database to create an order list in which the pieces of additional information are listed in a playback order of contents, and for selecting and extracting pieces of additional information to be listed in the above-mentioned order list according to the above-mentioned priority levels for the identical content data recorded into the plurality of types of recording media; and a content playback means for playing back content data recorded into the above-mentioned recording media in the playback order of the above-mentioned order list on a basis of path information acquired from the above-mentioned content database.

The content playback device in accordance with the present invention extracts pieces of additional information from the content database to create an order list in which the pieces of additional information are listed in a playback order of tracks, selects and extracts pieces of additional information to be listed in the order list from identical content data recorded into the plurality of types of recording media according to the priority levels based on the access times required to access the recording media respectively, and plays back content data recorded in the recording media in the playback order of the order list on the basis of track path information acquired from the content database. By doing in this way, the content playback device provides an advantage of being able to handle the plurality of types of recording media systematically, and search for and extract content data, such as musical pieces to be played back, without being aware of the types of recording media.

### BRIEF DESCRIPTION OF THE FIGURES

FIG. 1 is a block diagram showing the configuration of a content playback device in accordance with Embodiment 1 of the present invention;

FIG. 2 is a view showing an example of the configuration of a musical piece database shown in FIG. 1;

FIG. 3 is a view showing an example of the configuration of a track table;

FIG. 4 is a view showing an example of the configuration of a track title table;

FIG. 5 is a view showing an example of the configuration of an artist name table;

FIG. 6 is a view showing an example of the configuration of a playlist name table;

FIG. 7 is a view showing an example of the configuration of a folder table;

FIG. 8 is a view showing a hierarchical relationship among folders;

FIG. 9 is a view showing an example of the configuration of an order list creation track table;

FIG. 10 is a view showing an example of the configuration of a playlist table;

FIG. 11 is a view showing an example of the configuration of an order list creation playlist table;

FIG. 12 is a view showing an example of the configuration of an order list;

FIG. 13 is a block diagram showing the internal structure of an order list control means shown in FIG. 1, and the configuration of peripherals for the order list control means;

FIG. 14 is a flow chart showing a flow of an order list creating process in accordance with Embodiment 1;

FIG. 15 is a view showing a selection screen for selecting information to be included in the order list;

FIG. 16 is a view showing a case in which an item “artist name” shown in FIG. 15 is selected;

FIG. 17 is a view showing an example of display of the order list; and

FIG. 18 is a view showing another example of the selection screen.

### PREFERRED EMBODIMENTS OF THE INVENTION

### Embodiment 1

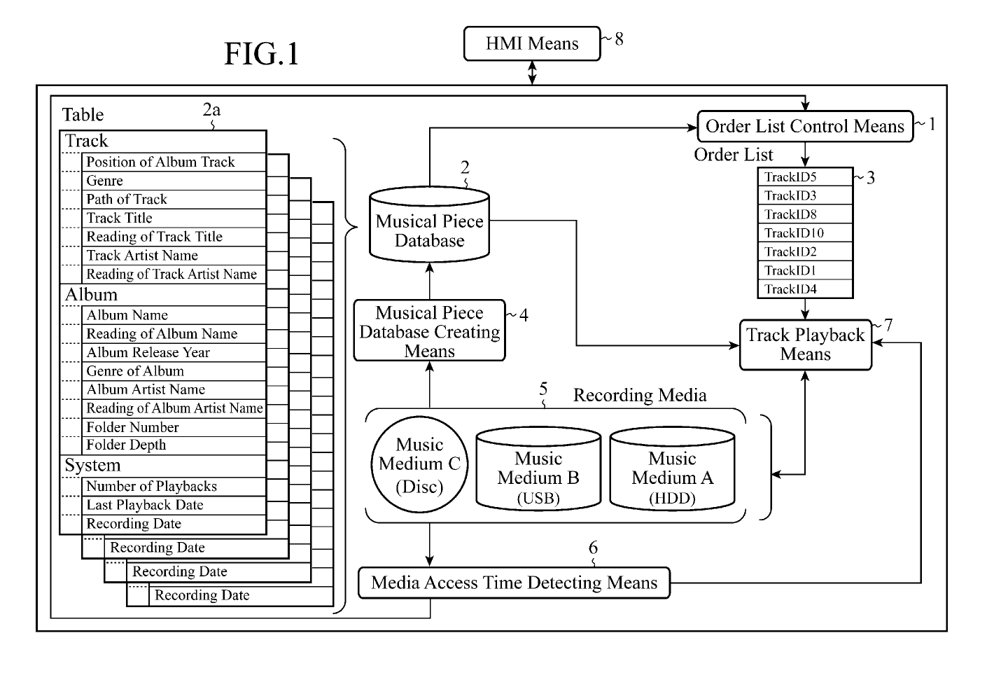

FIG. 1 is a block diagram showing the configuration of a content playback device in accordance with Embodiment 1 of the present invention, and shows a case in which the content playback device in accordance with the present invention is applied to a music playback device that plays back each of musical pieces as a content. As shown in FIG. 1, the content playback device in accordance with Embodiment 1 is provided with an order list control means 1, a musical piece database 2, a musical piece database creating means 4, a media access time detecting means 6, a track playback means 7, and an HMI means 8.

The order list control means 1 searches through the musical piece database 2 for pieces of additional information of music data on the basis of the contents of each table 2a to extract the pieces of additional information, and also creates an order list 3 in which the extracted pieces of additional information of music data are listed. The order list control means controls the playback order in which music data are to be played back by controlling the order of list items in this order list 3.

In the present invention, content data used for playing back and recording a musical piece or a video image, such as audio data, video data, karaoke data, incoming call melody data, podcast data, or mixed data including some of them, the content data including music data (e.g., MP3 music data), are referred to as a content. Furthermore, list data, such as playback order data, showing the playback order or the record order in which contents are to be played back or are recorded are referred to as an order list 3.

The musical piece database (content database) 2 is comprised of tables 2a in each of which pieces of additional information about music data recorded into various types of recording media 5 are registered. Attribution information of music data can be searched for and extracted by the order list control means 1. Each table 2a is table data in which additional information and so on, which are recorded in a recording medium 5 along with corresponding music data, are registered as the attribution information of the music data.

As the additional information of music data, information described in a musical piece data tag incorporated into the music data file can be provided. In a case in which the music data is MP3 (MPEG audio layer 3) data, the additional information includes “artist name, release year, and music name” which are described in an ID3 tag (ID3v1 tag, ID3v1.1 tag, ID3V2 tag, or the like).

More specifically, information including the genre (Genre) of the track (the music data), the title of the track (Track Title), the reading (kana reading) (Track Title YOMI) of the title of the track, the artist name (Artist Name), the reading of the artist name (Artist YOMI), the name of the album (playlist) (Playlist Name), the reading of the playlist name (Playlist YOMI), the track number in the album in which the track is recorded (Tracks), the date when the album was released (Album Year), and the genre (Album Genre) of the album is read.

The musical piece database creating means (a database creating means) 4 creates the musical piece database 2 by associating the additional information of each music data read from each of the recording media 5 with a track path or the like showing the storing position of the music data (track) to register the additional information into the tables 2a. Item information registered into the musical piece database 2 includes, for example, a track ID (Track ID) which is index information about an index to each table which constructs the tables 2a regarding tracks, a track path (Track Path) showing the storing position of each track, a folder number (Folder No) for specifying a folder corresponding to each track in a playlist (album) having a directory structure, and a folder depth (Folder Depth) showing the depth of each folder from the route folder in the directory tree.

As the recording media 5, a music medium A which is a hard disk drive (HDD) in which music data are recorded, a music medium B which is a USB memory in which music data are recorded, a music medium C which is a CD or DVD in which music data are recorded, etc. can be provided. In this case, drive devices and interfaces for use with the music media A to C are also included in the recording media 5.

The media access time detecting means (an access time detecting means) 6 detects an access time required to access music data recorded into each of the music media A to C via the above-mentioned drive devices and the above-mentioned interfaces for use with the recording media 5. For example, the access time required to access music data recorded into the music medium C depends upon a pickup (head) of the disk drive device for use with CD or DVD, and the position on the disc where the music data (music file) exists. Furthermore, the access time also depends upon the folder depth of the folder in which the music data exists. As the access time, a media average access time which is the average of the access times which are measured a predetermined number of times, a minimum access time which is the minimum of them, and a maximum access time which is the maximum of them can be provided.

According to the playback order of the tracks (musical pieces) set in the order list 3, the track playback means (content playback means) 7 specifies the music data of the music media which are defined by the track paths to play back each of the tracks. The HMI means 8 is a human-machine interface (HMI) for exchanging information between the content playback device and the user by using a not-shown input unit and a not-shown display unit. For example, the HMI means is controlled by the order list control means 1 and the track playback means 7 to display registration information stored in the musical piece database 2, the information about the order list 3, and the information about the track (music data) currently being played back on the display screen of the display unit. Furthermore, a voice recognition unit can be provided as the HMI means 8 so as to receive information via voice uttered by the user.

By causing a computer to read, for example, a program for configuring the content playback device in accordance with the scope of the present invention to control the operation of the program, the order list control means 1, the musical piece database creating means 4, the media access time detecting means 6, the track playback means 7, and the HMI means 8, which are mentioned above, can be implemented as a concrete means in which software and hardware work in cooperation with each other on the computer.

Furthermore, the musical piece database 2 and the order list 3 can be configured in a storage area of a storage unit (HDD) mounted in the above-mentioned computer, or can be configured in a storage area of an external device with which the order list control means 1, the musical piece database creating means 4, and the track playback means 7 can carry out data communications.

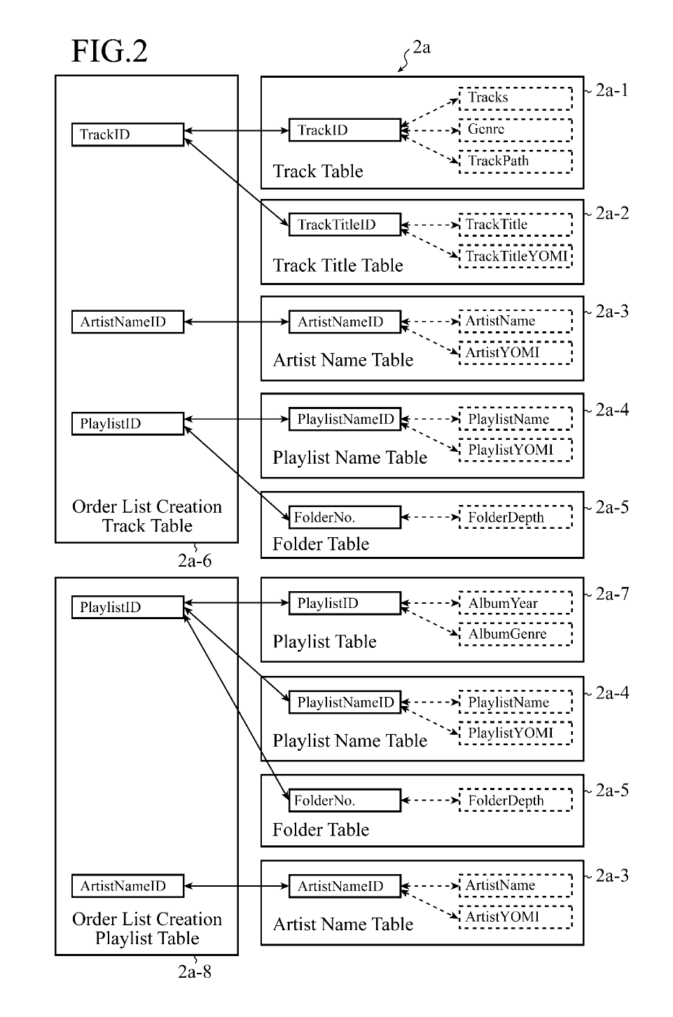

FIG. 2 is a view showing an example of the configuration of the musical piece database shown in FIG. 1. In a case in which the musical piece database 2 are formed on a track-by-track basis, the musical piece database 2 is comprised of, as shown in an upper portion of FIG. 2, a track table 2a-1, a track title table 2a-2, an artist name table 2a-3, a playlist name table 2a-4, a folder table 2a-5, and an order list creation track table 2a-6 with which these tables 2a-1 to 2a-5 are associated as low order layers. The tables 2a-1 to 2a-5 are associated with one another via the following three IDs: a track ID (Track ID), an artist name ID (Artist Name ID), and a playlist ID (Playlist ID), managed by the order list creation track table 2a-6.

The track table 2a-1 manages the additional information other than the titles of the tracks (musical piece titles). In this table, track IDs (Track IDs) each of which is index information about an index to each table which constructs the musical piece database 2, track paths (Track Paths) each showing the storing position of a track, track numbers (Tracks) in the album in each of which a track (musical piece) is recorded, and the genre (Genres) of each of the tracks are registered.

The track name table 2a-2 manages the additional information about the title of each of the tracks (musical piece title). In this table, track title IDs (Track Title IDs) each of which is associated with a track ID so that the track title ID serves as index information about an index to each table which constructs the musical piece database 2, track titles (Track Titles) each specified by a track title ID, and the reading (reading kana) (Track Title YOMI) of the title of each of the tracks are registered.

The artist name table 2a-3 manages the additional information about the artist name of each of the tracks. In this table, artist name IDs (Artist Name IDs) each of which is ID information for specifying an artist name in the musical piece database 2, artist names (Artist Names) each specified by an artist name ID, and the reading (reading kana) (Artist YOMI) of the artist name specified by each of the artist name IDs are registered.

The playlist name table 2a-4 manages the additional information about each playlist (album) name. In this table, playlist name IDs (Playlist Name IDs) each of which is ID information for specifying a playlist name in the musical piece database 2, playlist names (Playlist Names) each specified by a playlist name ID, and the reading (reading kana) (Playlist YOMI) of the playlist name specified by each of the playlist name IDs are registered.

The folder table 2a-5 manages the additional information about each folder corresponding to a playlist. In this table 2a-5, folder numbers (Folder No) each for specifying a folder corresponding to a playlist, and the depth (Folder Depth) of each folder showing the depth (hierarchical layer depth) of the folder hierarchically managed in the directory structure from the route folder (zero hierarchical layer (depth=0)) are registered.

The order list creation track table 2a-6 manages the tracks (musical pieces), and are table data for creating the order list in which the music data to be played back are listed on a track-by-track basis. In this table, the track IDs, the artist name IDs, and the playlist IDs are registered. The track table 2a-1 and the track title table 2a-2 are associated with the track IDs managed by the order list creation track table 2a-6.

The artist name table 2a-3 is associated with the artist name IDs managed by the order list creation track table 2a-6. The playlist name table 2a-4 and the folder table 2a-5 are associated with the playlist IDs managed by the order list creation track table 2a-6.

Thus, the tables 2a-1 to 2a-5 into which the pieces of additional information of the music data are grouped are associated with the three pieces of ID information registered into the order list creation track table 2a-6 respectively. Accordingly, on the basis of the information items in the tables 2a-1 to 2a-5, information which is a search object can be searched for and a specification of the information can be made. Furthermore, even if a change is made to the additional information of music data, the change of the additional information can be handled by sequentially specifying corresponding tables on the basis of the pieces of ID information stored in the order list creation track table 2a-6.

In addition, in a case in which the musical piece database 2 are formed on an album-by-album (playlist-by-playlist) basis, the musical piece database 2 is comprised of, as shown in a lower portion of FIG. 2, an artist name table 2a-3, a playlist name table 2a-4, a folder table 2a-5, a playlist table 2a-7, and an order list creation playlist table 2a-8 with which these tables 2a-3 to 2a-5 and 2a-7 are associated as low order layers. The tables 2a-3 to 2a-5 and 2a-7 are associated with one another via the following two types of IDs: playlist IDs and artist name IDs managed by the order list creation playlist table 2a-8.

The playlist table 2a-7 manages the additional information other than playlist (album) names. In this table, playlist IDs (Playlist ID) each of which is ID information for specifying a playlist in the musical piece database 2, the year (Album Year) in which each album (playlist) was released, and the genre (Album Genre) of each album are registered.

The order list creation playlist table 2a-8 manages the playlists (albums), and is table data for creating the order list in which the music data to be played back are listed on a per-playlist basis. The playlist IDs and the artist name IDs are registered into this table.

The playlist table 2a-7, the playlist name table 2a-4, and the folder table 2a-5 are associated with the playlist IDs managed by the order list creation playlist table 2a-8. The artist name table 2a-3 is associated with the artist name IDs managed by the order list creation playlist table 2a-8.

The tables 2a-3 to 2a-5 and 2a-7 into which the pieces of additional information of the music data are grouped are associated with the two pieces of ID information registered into the order list creation playlist table 2a-8 respectively. Accordingly, on the basis of the information items in the tables 2a-3 to 2a-5 and 2a-7, information which is a search object can be searched for and a specification of the information can be made from the additional information of the music data. Furthermore, even if a change is made to the additional information of music data, the change of the additional information can be handled by sequentially specifying corresponding tables on the basis of the pieces of ID information stored in the order list creation track table 2a-8.

Next, the operation of the content playback device will be explained.

(1) A process of creating the musical piece database First, when a folder which is associated with music data recorded into the HDD (music medium A) is selected by using the HMI means 8, the USB memory (music medium B) is connected to the USB connector, or the CD or DVD (music medium C) is mounted to the disk drive device, the content playback device places the music medium A, B, or C in an accessible state in which the music medium can be accessed by the musical piece database creating means 4.

When the music medium A, B, or C is placed in the accessible state, the musical piece database creating means 4 extracts the musical piece information tags (e.g., the ID3 tags of MP3 data) incorporated into the music data files currently recorded into the music medium A, B, or C, and searches through the described information to read the additional information described in each of the musical piece information tags. Furthermore, the musical piece database creating means 4 extracts information including the track paths, the folder numbers, the folder depths, etc., from the library information about the music data whose musical piece information tags have been read.

When placing the music medium A, B, or C in the accessible state, the musical piece database creating means 4 can display a selection screen in which the music names specified by the musical piece information tags read from the one of the music media A to C are listed on the display screen of the display unit to allow the user to select musical pieces from which the user desires to form the database by using the input unit.

Next, the musical piece database creating means 4 creates the musical piece database 2 by categorizing the pieces of information read as mentioned above into parts respectively corresponding to the information items of the tables 2a to register them. An explanation of the musical piece database 2 will be made with reference to the example shown in FIG. 2. The information about the tracks (musical pieces) among the pieces of information read from the musical piece information tags is grouped into the tables 2a-1 and 2a-2 associated with the order list creation track table via the track IDs, the information about the artist names is grouped into the table 2a-3 associated with the order list creation track table via the artist name IDs, and the information about the playlists is grouped into the tables 2a-4 and 2a-5 associated with the order list creation track table via the playlist IDs. These pieces of information are then registered.

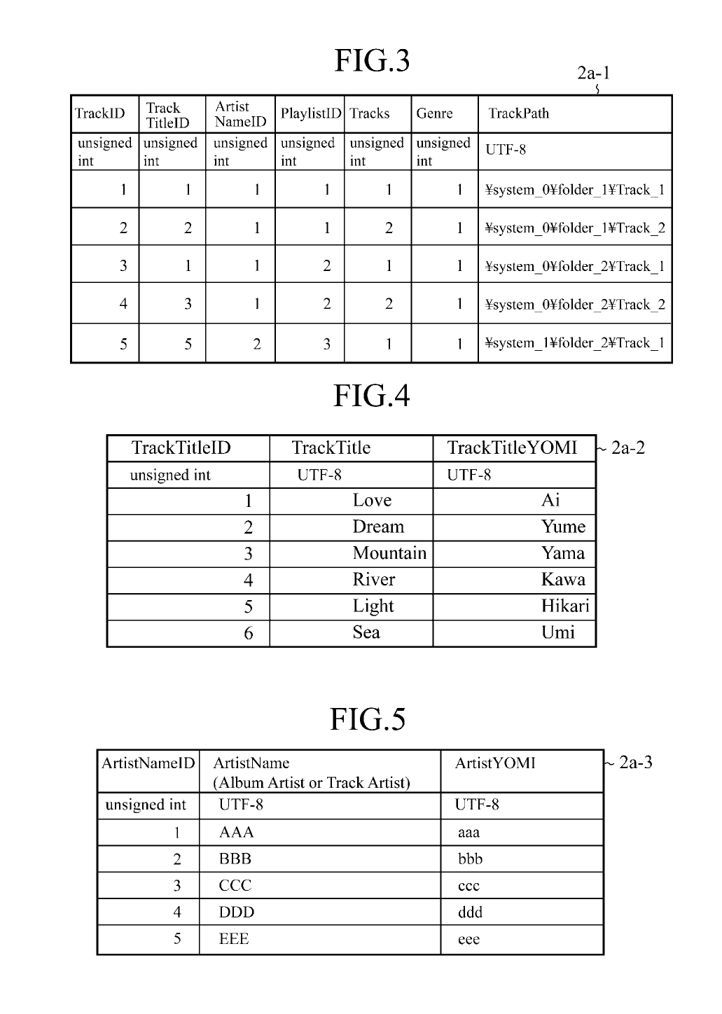

In this case, because each track ID of the order list creation track table 2a-6 is associated with a track ID of the track table 2a-1, as shown by an arrow in FIG. 2, the track table 2a-1 is associated with the track title IDs (Track Title IDs) in the track title table 2a-2. Furthermore, because each track ID is associated with a playlist ID in the order list creation track table 2a-6, a track ID, a track title ID, an artist name ID, a playlist ID, a track number (Tracks), a genre, and a track path are associated with one another in the track table 2a-1, as shown in FIG. 3.

The content playback device can know from this table 2a-1 that, for example, the information corresponding to a track ID=4 includes a track title ID=3, a track number=2, a genre=1, and a track path=¥system_{—}0¥folder_{—}2¥Track_{—}2. The track table 2a-1 has the attribute information about each track (musical piece) and the information about the position (storing position) of each track.

Furthermore, the track title table 2a-2 constructs table data in which track name IDs, track titles, and track title readings are registered as shown in FIG. 4. Character information which constructs each table is expressed by using, for example, UTF-8 which is a unicode character coding method.

The content playback device can know from this table 2a-2 that, for example, the information corresponding to a track name ID=3 includes a track title=“mountain” and a track title reading=“yama”. In the track name table 2a-2, the track titles are registered uniquely without being identical to one another. However, even different tracks can have the same title. Therefore, as the track title IDs of different tracks, the same track title ID can be registered.

Similarly, the artist name table 2a-3 constructs table data in which artist name IDs, artist names (album artist names or track artist names), and artist name readings are registered as shown in FIG. 5. The content playback device can know from this table that for example, the information corresponding to an artist name ID=1 includes an artist name=“AAA” and an artist name reading=“aaa”. In this table 2a-3, the artist names are registered uniquely without being identical to one another. However, even different artists can have the same family and personal name. Therefore, as the artist name IDs of different artists, the same artist name ID can be registered.

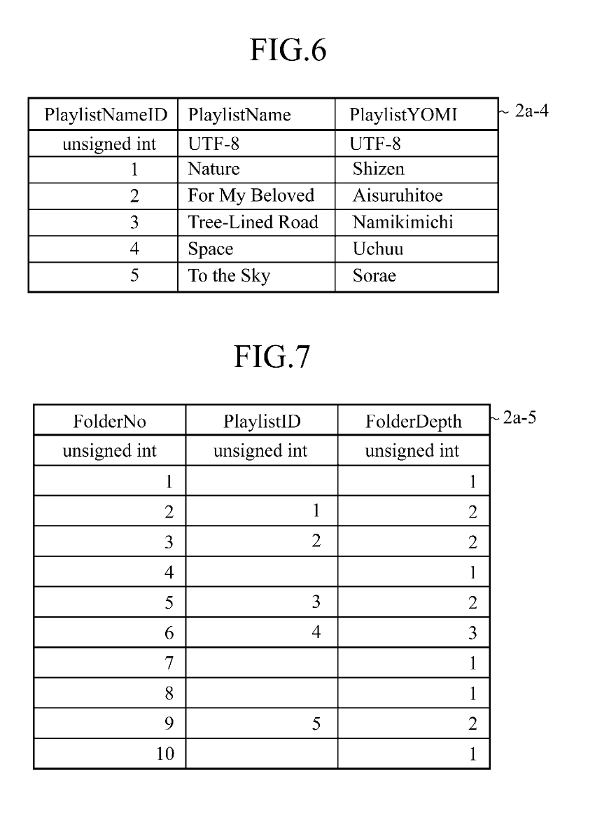

Furthermore, the playlist name table 2a-4 constructs table data in which playlist name IDs, playlist names, and playlist name readings are registered as shown in FIG. 6. The content playback device can know from this table that the information corresponding to a playlist ID=3 includes a playlist name=“a tree-lined road” and a playlist name reading=“namikimichi”. In this table 2a-4, the playlist names are registered uniquely without being identical to one another. However, even different playlists can have the same name. Therefore, as the playlist name IDs of different playlists, the same playlist name ID can be registered.

In addition, as shown by arrows in FIG. 2, a playlist name ID in the playlist name table 2a-4 and a folder number in the folder table 2a-5 are associated with a playlist ID in the order list creation track table 2a-6, and the folder table 2a-5 is associated with the playlist name IDs in the playlist name table 2a-4. Accordingly, as shown in FIG. 7, in the folder table 2a-5, a folder number, a playlist ID, and the depth of a folder are associated with one another.

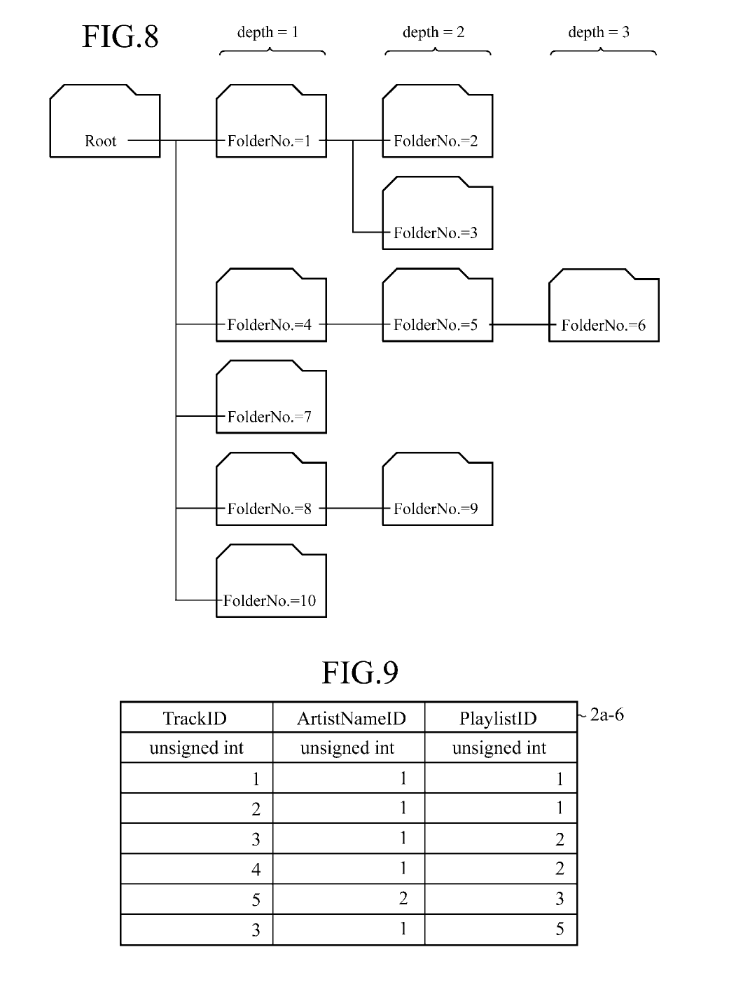

FIG. 8 is a view showing a hierarchical relationship among folders with each of which music data are associated. The folder table 2a-5 shown in FIG. 7 is obtained by structurizing the relationship shown in FIG. 8. The content playback device can know from the folder table 2a-5 that the information corresponding to a folder number=2 includes a playlist ID=1 and a folder depth=2. By thus referring to the registered contents of the folder table 2a-5, the content playback device can know the hierarchical relationship among the folders, the positions of the folders, and that each of the folders includes tracks (musical pieces). In other words, the content playback device can determine whether each of the folders corresponds to a playlist.

After creating the tables 2a-1 to 2a-5 in the above-mentioned way, the musical piece database creating means 4 establishes music data associations by using the track IDs, the artist name IDs, and the playlist IDs, and registers these pieces of ID information into the order list creation track table 2a-6. Accordingly, in the musical piece database 2, the tables 2a-1 to 2a-6 are associated with one another via the above-mentioned three pieces of ID information.

By referring to the order list creation track table 2a-6, the content playback device can know that the information corresponding to a track ID=3 includes an artist name ID=1 and a playlist ID=2 as shown in FIG. 9. Furthermore, by referring to the track table 2a-1 and the order list creation track table 2a-6 shown in FIG. 3, the content playback device can know, via the track ID, that the information corresponding to a track name=1 includes a track number=1, a genre=1, and a track path=¥system_{—}0¥folder_{—}2¥Track_{—}1.

In addition, by referring to the artist name table 2a-3 and the order list creation track table 2a-6 shown in FIG. 5, the content playback device can recognize, via the artist name

ID, an artist name=“AAA” and an artist name reading=“aaa”. Furthermore, by referring to the playlist name table 2a-4 and the order list creation track table 2a-6 shown in FIG. 6, the content playback device can know, via the playlist ID, that the information corresponding to the playlist name ID=2 includes a playlist name=“For my beloved” and a playlist name reading=“aisuruhitoe”.

In contrast, in the case in which the musical piece database is formed on an album-by-album (playlist-by-playlist) basis, the musical piece database creating means 4 categorizes the information regarding the playlists, among the pieces of information read from the musical piece information tags, into the tables 2a-7, 2a-4, and 2a-5 associated with the order list creation playlist table via the playlist IDs, and also categorizes the information about the artist names into the table 2a-3 associated with the order list creation playlist table via the artist name IDs to register them.

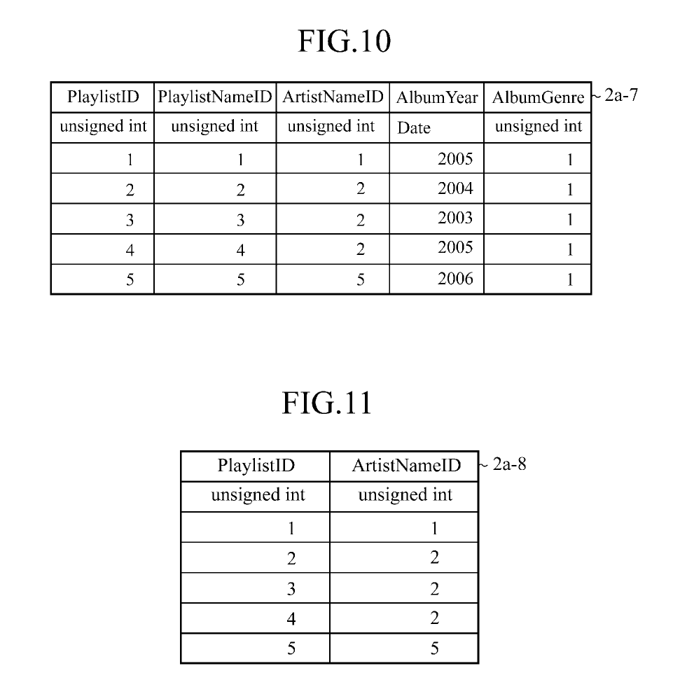

In this case, as shown by arrows in FIG. 2, because each playlist ID in the playlist table 2a-7 is associated with a playlist ID in the order list creation playlist table 2a-8, the playlist table 2a-7 is associated with the playlist name IDs (Playlist Name IDs) in the playlist name table 2a-4. Furthermore, because each playlist ID is associated with an artist name ID in the order list creation playlist table 2a-8, a playlist ID, a playlist name ID, an artist name ID, an album release year, and an album genre are associated with one another in the playlist table 2a-7, as shown in FIG. 10.

In the example of FIG. 10, the content playback device can know from the playlist table 2a-7 that the information corresponding to a playlist ID=2 includes a playlist name ID=2, an artist name ID=2, an album release year=2004, and an album genre=1. Thus, each playlist's attribute information is registered in the playlist table 2a-7.

After creating the tables 2a-3 to 2a-5 and 2a-7 in the above-mentioned way, the musical piece database creating means 4 establishes music data associations by using the playlist IDs and the artist name IDs, and registers these pieces of ID information into the order list creation playlist table 2a-8. Accordingly, in the musical piece database 2, the tables 2a-3 to 2a-5 and 2a-7 are associated with one another via the above-mentioned two pieces of ID information.

By referring to the order list creation playlist table 2a-8, the content playback device can know that a playlist ID=4 corresponds to an artist name ID=2, as shown in FIG. 11. Furthermore, by referring to the playlist table 2a-7 and the order list creation playlist table 2a-8 shown in FIG. 10, the content playback device can know, via the playlist ID, that the information corresponding to a playlist name ID=4 includes an album release year=2005 and an album genre=1.

In addition, by referring to the artist name table 2a-3 and the order list creation playlist table 2a-8 shown in FIG. 5, the content playback device can recognize, via the artist name ID, that an artist name reading corresponding to an artist name=“BBB” is “bbb”. Furthermore, by referring to the playlist name table 2a-4 and the order list creation playlist table 2a-8 shown in FIG. 6, the content playback device can know, via the playlist name ID, that a playlist name reading corresponding to a playlist name=“space” is “uchuu”.

Thus, in the musical piece database 2, the additional information of music data recorded into each of the various recording media 5 is grouped and registered into the various tables of the table set 2a which are associated with one another via the three pieces of ID information including the track IDs, the artist name IDs, and the playlist IDs. As a result, the additional information of music data recorded into each of the various recording media 5 is managed systematically in the musical piece database 2 without being dependent upon the types of the recording media 5.

Furthermore, when making a specification of information which is a search object, making a search for information which is a search object, or performing a process of registering information into the order list 3 in the musical piece database 2, the content playback device can carry out the above-mentioned process easily without being aware of the types of recording media 5 by following the associations among the pieces of information with reference to the items of the various tables which construct the table set 2a. Even if a change is made to the additional information of music data, the content playback device has only to change the associated information of the music data in the tables.

(2) A Process of Creating an Order List

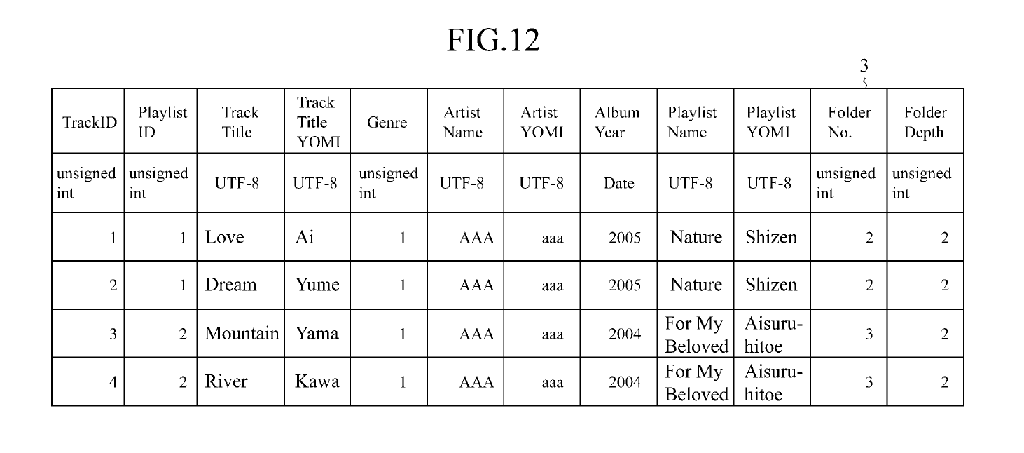

By combining the tables 2a-1 to 2a-5 and 2a-7 as shown in FIGS. 3 to 8 and 10, an order list 3 is created. The order list 3 has a list structure as shown in FIG. 12, and is a set of pieces of information about the tracks or playlist corresponding to the music data to be played back. In the order list 3 shown in FIG. 12, track IDs are indexes to the various tables 2a-1 to 2a-5 into which the pieces of information about the tracks (musical pieces) are registered, and playlist IDs are indexes to the various tables 2a-3 to 2a-5 and 2a-7 into which the pieces of information about the playlists (albums) are registered.

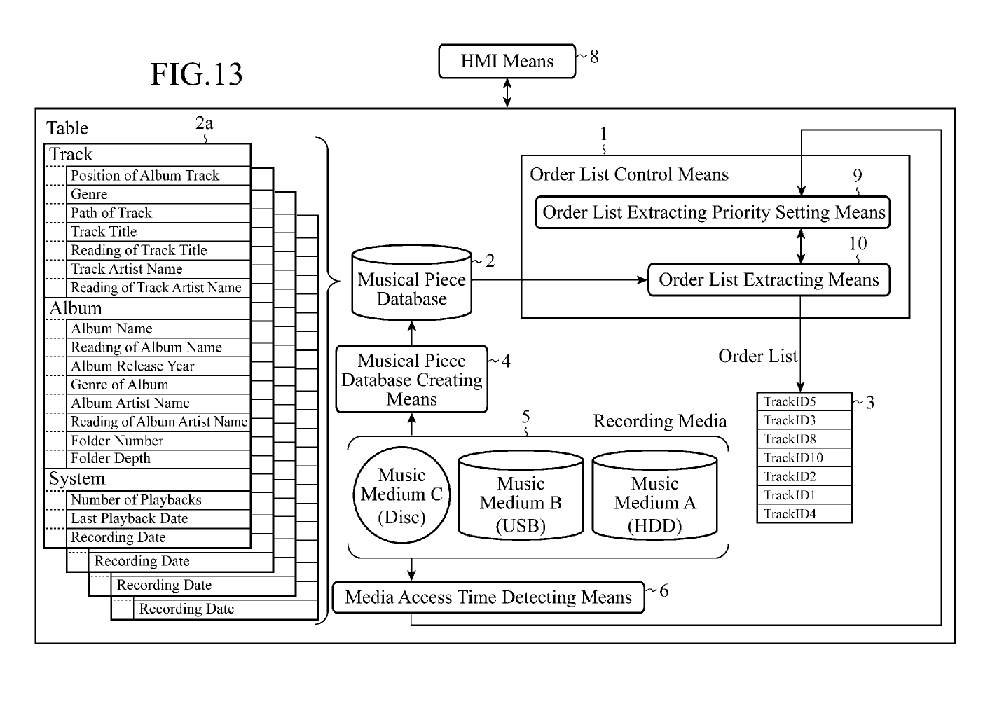

FIG. 13 is a block diagram showing the internal structure of the order list control means shown in FIG. 1, and the configuration of peripherals for the order list control means. In the figure, among the components of the order list control means 1, only components for extracting pieces of information to be included in the order list 3 from the musical piece database 2 are selectively shown. As shown in FIG. 13, the order list control means 1 is provided with an order list extracting priority setting means 9 and an order list extracting means 10 as the components for extracting pieces of information to be included in the order list 3 from the musical piece database 2.

The order list extracting priority setting means (a priority level setting means) 9 determines priority levels for pieces of additional information of tracks having the same contents, the priority levels being considered at the time of extracting them from the musical piece database 2, in consideration of the access times required to respectively access the recording media 5 and detected by the media access time detecting means 6. The order list extracting means 10 lists pieces of additional information in the playback order of the music data from the musical piece database 2 to create the order list 3, and, as to the tracks having the same contents recorded into the different types of recording media 5, also selects pieces of additional information to be listed on the basis of the priority levels determined by the order list extracting priority setting means 9.

Next, the details of the process of creating the order list will be explained.

As a process in preparation for the creation of the order list, the media access time detecting means 6 detects the media access time required to access each of the recording media 5 when the musical piece database creating means 4 accesses the various recording media 5 to create the musical piece database 2. For example, the media access time detecting means 6 measures the disk access time required to access each of the music media A and C including a head operation, and the access time required to access the USB memory in the music medium B.

Instead of performing the media access time detecting process as a process in preparation for the creation of the order list, the media access time detecting means 6 can detect the media access time required to access each of the recording media while the order list control means 1 carries out the order list creating process. The media access time required to access each of the recording media 5 which is measured in this way is informed from the media access time detecting means 6 to the order list extracting priority setting means 9.

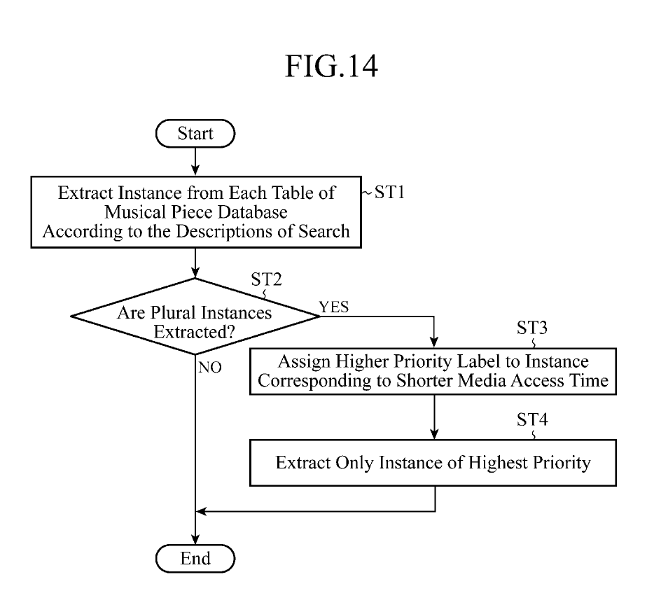

FIG. 14 is a flow chart showing a flow of the order list creating process in accordance with Embodiment 1, and the details of the order list creating process carried out by the components shown in FIG. 13 will be explained with reference to this flow chart. In order to create the order list 3, the content playback device has to present pieces of additional information of music data for the user, and search for and extract pieces of information to be included in the order list 3.

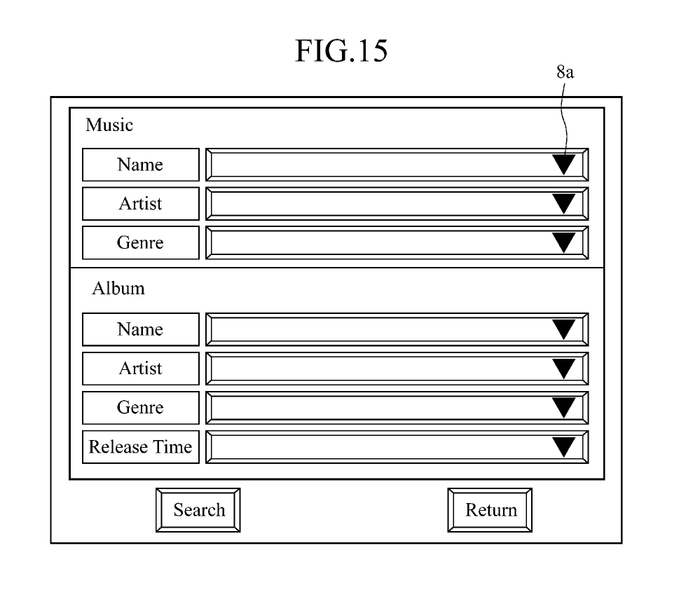

Therefore, the order list extracting means 10 reads the pieces of additional information registered into the tables 2a of the musical piece database 2, and displays a selection screen which enables the user to select attribution information of musical piece (track) or album (playlist) registered into the musical piece database 2 as shown in FIG. 15 on the display screen of the display unit which constructs the HMI means 8. In the example of FIG. 15, on the display screen of the display unit, a selection screen in which “music name”, “artist name”, and “genre” regarding music are shown as items to be selected, and “album name”, “artist name”, “genre”, and “release time” regarding album are shown as items to be selected is displayed as an HMI via which the user can select attribution information by using a not-shown input unit.

On the basis of one of “music name”, “artist name”, and “genre” regarding music or one of “album name”, “artist name”, “genre”, and “release time” regarding album which is selected in this selection screen, the content playback device can search through the various tables 2a of the musical piece database 2 to extract information. As an alternative, plural items regarding music or plural items regarding album can be selected in the selection screen, and the content playback device can search through the various tables of the musical piece database on the basis of the plural items. For example, by clicking a solid filled downward triangular mark 8a displayed in each item field shown in FIG. 15, the user can select a plurality of pieces of additional information grouped into the identical item.

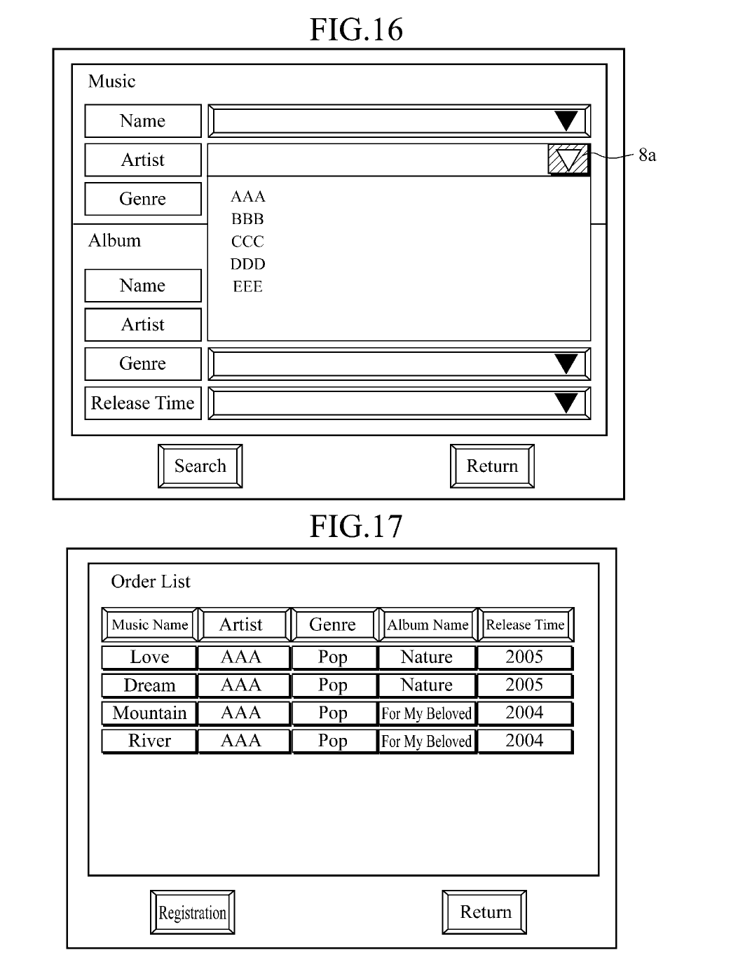

FIG. 16 is a view explaining a case in which the content playback device searches through the musical piece database using “artist name” regarding music, and shows a state in which the user clicks the solid filled downward triangular mark 8a of the item “artist name” shown in FIG. 15. As shown in FIG. 16, when the user clicks and selects the above-mentioned triangular mark, all the artist names registered into the musical piece database 2 are displayed in a window frame.

More specifically, when the user selects the above-mentioned triangular mark 8a in the artist column, the order list extracting means 10 extracts the artist name columns in the artist name table 2a-3 shown in FIG. 5 and displays all the artist names registered into the artist name table 2a-3 on the selection screen.

This process is expressed in a database language as follows.

SELECT Artist Name

FROM Artist Name Table;

The content playback device can form a selection screen as shown in FIG. 16 by displaying Artist Name ( ) which it has acquired through the process on the display unit. When the data amount of the artist names overflows the screen, the content playback device can display them in a window having a scrolling feature.

When the user specifies an artist name by using a not-shown input unit, the order list extracting means 10 reads all the pieces of additional information associated with the specified artist name from the musical piece database 2. For example, when “AAA” is selected, the order list extracting means 10 extracts “AAA” registered into the artist names of the artist name table 2a-3 shown in FIG. 5, and also follows the associations via the ID information with reference to the order list creation track table 2a-6 (or the order list creation playlist table 2a-8) which is formed in the musical piece database 2 to search for and extract pieces of information stored in the various tables and associated with the artist name “AAA”.

A voice recognition unit can be provided as the HMI means 8, and can be configured in such a way as to recognize a voice uttered by the user to input an artist name as mentioned above. The process mentioned until now corresponds to step ST1.

The order list extracting means 10 then determines whether or not instances of an identical track extracted from the musical piece database 2 are pieces of information coming from the plurality of recording media 5 (step ST2). For example, when the user selects an artist name “AAA” in the selection screen shown in FIG. 16, the order list extracting means determines whether the pieces of information associated with this artist name come from the plurality of recording media 5. At this time, unless the instances are extracted from the plurality of recording media 5, the order list extracting means 10 creates the order list 3 by using the information extracted in step ST1.

To be more specific, when “AAA” is selected as an artist name in the selection screen shown in FIG. 16, and the order list extracting means 10 searches for and extracts pieces of information stored in the various tables and associated with the artist name “AAA” from the musical piece database 2 first, the order list extracting means creates the order list creation track table 2a-6 as shown in FIG. 9 by using the extracted pieces of information.

This process is expressed in a database language as follows.

CREATE TrackOrderControlTable AS
SELECT

| | |
|---|---|
| TrackTable.TrackID | TrackID, |

| | |
|---|---|
| TrackTable.ArtistNameID | ArtistNameID, |

| | |
|---|---|
| TrackTable.PlaylistID | PlaylistID, |

| | |
|---|---|
| FROM | TrackTable,ArtistNameTable |

| | |
|---|---|
| WHERE | ArtistNameTable.ArtistName IN (“AAA”) |

AND

ArtistNameTable.ArtistNameID=TrackTable.ArtistNameI
D;

After creating the order list generation track table 2a-6 in the above-mentioned way, the order list extracting means 10 then creates the track table 2a-1, the track title table 2a-2, the artist name table 2a-3, the playlist name table 2a-4, and the folder table 2a-5, which are associated with the pieces of ID information of the order list generation track table 2a-6 by using the instances extracted in step ST1, and combines these tables to create the order list 3 as shown in FIG. 12.

In the example of FIG. 12, the order list extracting means creates the order list 3 by setting, as attribute items, track ID, playlist ID, track title, track title reading, genre, artist name, artist name reading, album issue year, playlist name, playlist name reading, folder number, and folder depth, which are included in the information registered into the track table 2a-1, the track title table 2a-2, the artist name table 2a-3, the playlist name table 2a-4, and the folder table 2a-5. Hereafter, an explanation will be made assuming that the order list 3 is created from these pieces of attribute item information.

This process is expressed in a database language as follows.

CREATE OrderList AS

| | | |
|---|---|---|
| AND | TrackOrderControlTable.PlaylistID | = |

FolderTable.PlaylistID

After creating the order list 3 in the above-mentioned way, the order list extracting means 10 presents the contents of the order list 3 which are the results of the creation for the user by displaying an order list screen as shown in FIG. 17 on the display screen.

Furthermore, when instances are extracted from the plurality of recording media 5 in step ST2, the order list extraction priority means 9 determines priority levels of extracting processing for the instances extracted from the plurality of recording media 5 respectively on the basis of the access times of the music media A to C informed thereto from the media access time detecting means 6. In this case, the order list extracting priority setting means 9 assigns a higher priority label to an instance of a recording medium 5 having a shorter access time (step ST3).

The order list extracting means 10 then makes a comparison among the priority labels which are assigned to the instances extracted from the plurality of recording media 5 by the order list extracting priority setting means 9, and extracts only the instance having the highest priority to use this instance for the creation of the order list 3 (step ST4). The process of creating the order list 3 is the same as the above-mentioned process.

As an alternative, the content playback device can be configured in such a way as to, in step ST1, when the user specifies a desired artist name by inputting a part of a character string which constructs the artist name using a not-shown input unit, instead of selecting one from artist names listed as shown in FIG. 16, search for and extract the corresponding artist name.

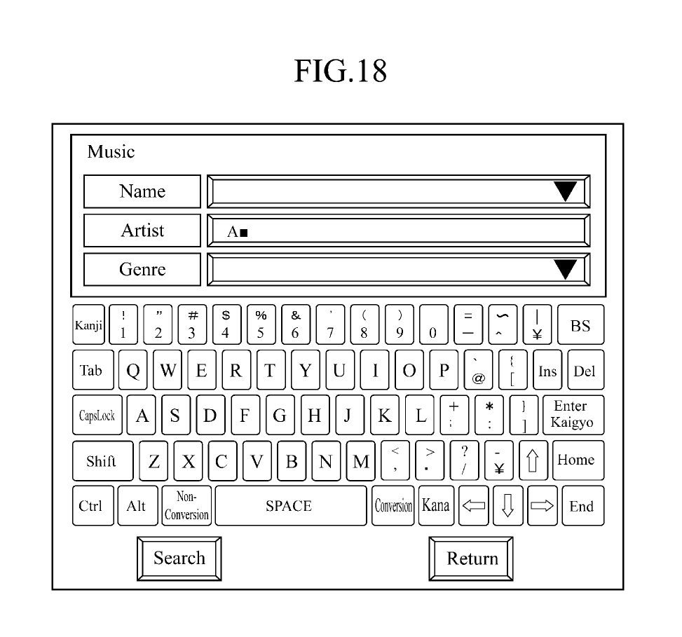

For example, when the content playback device displays a software keyboard as shown in FIG. 18 in a part of the selection screen and “A” is inputted as a character input by the user using this software keyboard, the search as mentioned above is expressed in a database language as follows. As a result, the process of extracting the artist names corresponding to “A” to extract the information associated with these artist names is the same as the above-mentioned process.

CREATE TrackOrderControlTable AS

SELECT

| | |
|---|---|
| TrackTable.TrackID | TrackID, |

| | |
|---|---|
| TrackTable.ArtistNameID | ArtistNameID, |

| | |
|---|---|
| TrackTable.PlaylistID | PlaylistID, |

| FROM TrackTable,ArtistNameTable | | |
|---|---|---|
| WHERE ArtistNameTable.ArtistName LIKE ‘%A%’ | | |
| AND | ArtistNameTable.ArtistNameID | = |

TrackTable.ArtistNameID;

Furthermore, the content playback device, in step ST1, can select a plurality of items and combine these items to extract the information associated with the combined items from the musical piece database 2. For example, when the content playback device combines a music name “dream” with an artist name “AAA” and extracts the information associated with these combined items, this process can be expressed in a database language as follows. The process of extracting the information from the musical piece database 2 is the same as the above-mentioned process.

CREATE TrackOrderControlTable AS

SELECT

| | |
|---|---|
| TrackTable.TrackID | TrackID, |

| | |
|---|---|
| TrackTable.ArtistNameID | ArtistNameID, |

| | |
|---|---|
| TrackTable.PlaylistID | PlaylistID, |

| FROM TrackTable,ArtistNameTable, TrackTitleTable | | |
|---|---|---|
| WHERE ArtistNameTable.ArtistName IN (“AAA”) | | |
| AND | ArtistNameTable.ArtistNameID | = |

TrackTable.ArtistNameID;

| | |
|---|---|
| AND | TrackTitleTable.TrackTitle LIKE ‘%dream%’ |

| | | |
|---|---|---|
| AND | TrackTitleTable.TrackTitleID | = |

TrackTable.TrackTitleID;

The case in which the content playback device searches for and extracts information regarding tracks (musical pieces) from the musical piece database 2 to create the order list 3 is shown above. Also in a case in which the content playback device searches for and extracts information regarding albums (playlists) to create an order list 3, the content playback device operates in the same way. For example, by searching for information on a per album (playlist) basis and extracting the information from the musical piece database 2, and then creating an order list generation playlist table 2a-8 as shown in FIG. 11 by using the extracted information, the content playback device can create an order list 3.

(3) Process of Setting a Playback Order in the Order List

After creating the order list 3 as mentioned above, the order list control means 1 searches through the musical piece database 2 with the pieces of information about the items registered into this order list 3, and sorts the playback order of the listed items according to the ascending or descending order of the items in the musical piece database 2. At this time, after sorting the playback order of the listed items according to the ascending or descending order of the items in the musical piece database 2, the order list control means 1 can display a selection screen for determination of the track playback order of the order list 3 on the display screen of the display unit to enable the user to selectively determine a desired playback order by using a not-shown input unit.

(4) A Process of Playing Back Contents

The order list 3 in which the playback order is set is stored in a not-shown memory disposed in the order list control means 1. When a playback request is made by the user via the HMI means 8, the track playback means 7 inputs the information about each of the tracks in the playback order of the order list 3, searches through the musical piece database 2 with the track ID corresponding to the track in question to read the track path from the track table 2a-1, and stores the track path therein. This process can be expressed in a database language as follows.

SELECT

TrackTable. TrackPath TrackPath
FROM TrackTable,Orderlist
WHERE Orderlist.rowid=1
AND Orderlist.TrackID=TrackTable.TrackID;

The track playback means 7 accesses the music data in the corresponding recording medium 5 on the basis of the track paths which the track playback means has acquired in the above-mentioned way, and carries out the playback process. For example, in the case of the order list 3 shown in FIG. 12, the track playback means sequentially plays back the tracks starting from the first track in the list whose track name is “love”. At this time, the track playback means 7 can display the additional information and playback state of the music data currently being played back on the display screen of the display unit.

As mentioned above, the content playback device in accordance with this Embodiment 1 extracts pieces of additional information from the musical piece database 2 to create an order list 3 in which the pieces of additional information are listed in a playback order of tracks, selects and extracts pieces of additional information to be listed in the order list 3 from identical content data recorded into a plurality of types of recording media 5 according to priority levels based on the access times required to access the recording media 5 respectively, and plays back musical piece data recorded into the recording media 5 in the playback order of the order list 3 on the basis of track paths acquired from the musical piece database. By doing in this way, the content playback device can handle the plurality of types of recording media systematically, and can search for and extract content data, such as musical pieces to be played back, without being aware of the types of recording media.

In above-mentioned Embodiment 1, the case in which music data, such as MP3 (MPEG audio layer 3) data, are handled is explained, though the present invention is not limited to this example. For example, even in a case of content data about a content, such as a musical piece or a video image, including audio data, video data, karaoke data, incoming call melody data, podcast data, or mixed data including some of them, the content playback device can handle the content data similarly.

### INDUSTRIAL APPLICABILITY

As mentioned above, in order to be able to search for and extract content data, such as musical pieces which are objects to be played back, without being aware of a plurality of types of recording media by handling the plurality of types of recording media systematically, the content playback device in accordance with the present invention is configured in such a way as to include a database creating means for creating a content database into which pass information showing a recording place of content data about a content is registered, an access time detecting means for detecting an access time required to access the content data, a priority level setting means for assigning a priority level to additional information about the content, an order list extracting means for creating an order list of contents, and for selecting and extracting pieces of additional information to be listed, and a content playback means for playing back content data. Therefore, the content playback device in accordance with the present invention is suitable for use as a content playback device that reads and plays back content data about a content, such as a musical piece or a video image, including MP3 (MPEG audio layer 3) data, audio data, video data, karaoke data, incoming call melody data, podcast data, or mixed data including some of them.

1. A content playback device comprising:
a database creating unit for extracting pieces of additional information each for specifying a content from a plurality of types of recording media into which content data and said pieces of additional information are recorded to create a content database into which path information showing a recording place of said additional information and said content data are registered for each content;
an access time detecting unit for detecting an access time required to access content data recorded into each of said recording media;
a priority level setting unit for, in a case in which identical content data is recorded into each of said plurality of types of recording media, assigning priority levels to pieces of additional information of the contents respectively according to the access time required to access content data recorded into each of the recording media which is detected by said access time detecting unit;
an order list extracting unit for extracting pieces of additional information from said content database to create an order list in which the pieces of additional information are listed in a playback order of contents, and for selecting and extracting pieces of additional information to be listed in said order list according to said priority levels for the identical content data recorded into the plurality of types of recording media; and
a content playback unit for playing back content data recorded into said recording media in the playback order of said order list on a basis of path information acquired from said content database.

2. The content playback device according to claim 1, wherein the order list extracting unit displays a selection screen for selecting information about each of items which construct the additional information registered into the content database on a display unit, accepts an input of selection of pieces of item information which construct the pieces of additional information to be listed in the order list according to said selection screen, and, on a basis of the selected pieces of item information of the additional information, creates the order list in which the pieces of additional information corresponding to said pieces of item information which said order list extracting unit has extracted by searching through said content database are listed in the playback order of contents, and also selects the pieces of additional information to be listed in said order list from the identical content data recorded into the plurality of types of recording media according to said priority levels set by said priority level setting unit.

3. The content playback device according to claim 1, wherein the order list extracting unit displays a selection screen for presenting each of the pieces of item information which construct the additional information of each content in a list form.

4. The content playback device according to claim 1, wherein said content playback device has a voice recognition unit for recognizing a voice uttered, and, on a basis of item information of additional information recognized by said voice recognition unit, the order list extracting unit creates the order list from pieces of additional information corresponding to said pieces of item information which said order list extracting unit has extracted by searching through the content database.

5. A program that causes a computer operate as the content playback device according to claim 1.
